(19) United States
(12) Patent Application Publication
(10) Pub. No.: US 2007/0208811 A1
(43) Pub. Date: Sep. 6, 2007

(54) INFORMATION EXCHANGE SUPPORT DEVICE, INFORMATION EXCHANGE SUPPORT METHOD, AND INFORMATION EXCHANGE SUPPORT PROGRAM

(75) Inventor: Tsuyoshi Ueno, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 10/599,556

(22) PCT Filed: Apr. 4, 2005
(86) PCT No.: PCT/JP05/06607

§ 371 Date: Oct. 2, 2006

(30) Foreign Application Priority Data
Apr. 7, 2004 (JP) 2004-112855

(51) Int. Cl. G06F 15/16

(52) U.S. Cl. 709/206

(57) ABSTRACT

An information exchange support apparatus for determining that an exchange condition of information to be exchanged is met between identified exchanging parties and reliably executing exchange of the information to be exchanged between the exchanging parties is provided.

An information exchange support apparatus 1 includes reception means 101, exchange determination means 102, transmission means 103, and storage means 104. The reception means 101 receives exchange request information containing the information to be exchanged and information identifying the exchanging party from a terminal. The transmission means 103 transmits the information to be exchanged contained in the received exchange request information to the terminal of the exchanging party. The exchange determination means uses the received exchange request information to determine whether or not information exchange is permitted; the exchange determination means determines that information exchange is permitted at least if the exchange request information from the mutual exchanging parties is already received.

### TECHNICAL FIELD

This invention relates to an information exchange support apparatus, an information exchange support method, and an information exchange support program and more particularly to an information exchange support apparatus, an information exchange support method, and an information exchange support program for determining that an exchange condition of information to be exchanged is met between identified exchanging parties and executing exchange of the information to be exchanged between the exchanging parties.

### BACKGROUND ART

Hitherto, to exchange information between the users of mobile telephones, etc., the information to be exchanged has been transmitted directly between the exchanging parties and thus there has been a possibility that either exchanging party cannot get the information to be exchanged if transmission of both parties is not executed.

As a method of solving this problem, it is possible to execute information exchange through the mediation of a server. As for execution of information exchange using a server, a network auction is known (refer to patent document 1).

However, the information exchange described in patent document 1 is exchange of information to define the details of the transaction and does not involve exchange of the information itself. To execute transaction in the information itself such as exchange of the information to be exchanged like an image, audio, etc., it is not guaranteed that the information to be exchanged can be mutually reliably gotten.

Patent document 1: JP-A-2001-283030

### DISCLOSURE OF THE INVENTION

### Problems that the Invention is to Solve

It is therefore an object of the invention to provide an information exchange support apparatus, an information exchange support method, and an information exchange support program for determining that an exchange condition of information to be exchanged is met between identified exchanging parties and reliably executing exchange of the information to be exchanged between the exchanging parties.

### Means for Solving the Problems

The information exchange support apparatus of the invention is an information exchange support apparatus for supporting exchange of information through a network, including reception means for receiving exchange request information containing information to be exchanged and information for identifying an exchanging party, exchange determination means for determining whether or not information exchange is permitted using the received exchange request information, and transmission means for transmitting the information to be exchanged to the exchanging party if the exchange determination means determines that information exchange is permitted, wherein, if the exchange request information from the mutual exchanging parties is already received, the exchange determination means determines that information exchange is permitted.

Therefore, according to the invention, it is determined that the exchange condition of the information to be exchanged is met between the identified exchanging parties, and exchange of the information to be exchanged between the exchanging parties can be executed reliably.

The information exchange support apparatus of the invention contains an apparatus, wherein, if the types of information to be exchanged contained in the exchange request information from the mutual exchanging parties match, the exchange determination means determines that information exchange is permitted.

Therefore, according to the invention, the types of information to be exchanged can be matched with each other.

The information exchange support apparatus of the invention contains an apparatus, wherein, if the types and the contents of information to be exchanged contained in the exchange request information from the mutual exchanging parties match, the exchange determination means determines that information exchange is permitted.

Therefore, according to the invention, the types and the contents of the information to be exchanged can be matched with each other.

The information exchange support apparatus of the invention contains an apparatus, wherein, if the types or the contents of information to be exchanged match a predetermined type or content of information to be exchanged, the exchange determination means determines that information exchange is permitted.

Therefore, according to the invention, the types or the contents of the information to be exchanged can be matched with the predetermined type or content of information to be exchanged.

The information exchange support apparatus of the invention contains an apparatus, wherein the exchange request information contains information indicating the type of information to be exchanged requested for the exchanging party, and wherein, if the types of information to be exchanged contained in the exchange request information from the mutual exchanging parties match the requested type for the exchanging party, the exchange determination means determines that information exchange is permitted.

Therefore, according to the invention, the types of information to be exchanged can be matched with the requested types for the exchanging parties.

The information exchange support apparatus of the invention contains an apparatus, wherein the exchange request information contains information indicating the type and the content of information to be exchanged requested for the exchanging party, and wherein, if the types and the contents of information to be exchanged contained in the exchange request information from the mutual exchanging parties match the requested type and content for the exchanging party, the exchange determination means determines that information exchange is permitted.

Therefore, according to the invention, the types and the contents of the information to be exchanged can be matched with the requested types and contents for the exchanging parties.

The information exchange support apparatus of the invention contains an apparatus, wherein the exchange request information contains content report information indicating the content of information to be exchanged contained in the exchange request information, and wherein, if the content report information matches the content of the received information to be exchanged, the exchange determination means determines that information exchange is permitted.

Therefore, according to the invention, the contents of the information to be exchanged can be matched with the contents reported by the exchanging parties.

The information exchange support apparatus of the invention contains an apparatus, wherein the reception means receives the exchange request information using an electronic mail system or a Web page.

The information exchange support apparatus of the invention contains an apparatus, wherein the transmission means transmits the information to be exchanged using an electronic mail system or a Web page.

The information exchange support apparatus of the invention contains an apparatus further includes preliminary disclosure means for preliminarily disclosing the information to be exchanged for the exchanging party, wherein, if consent information indicating exchange consent is received from the mutual exchanging parties after the preliminary disclosure means preliminarily discloses the information to be exchanged, the exchange determination means determines that information exchange is permitted.

Therefore, according to the invention, information exchange can be executed with consent obtained mutually from the exchanging parties.

The information exchange support apparatus of the invention contains an apparatus, wherein the exchange request information contains preliminary disclosure and consent required/not required information indicating whether or not exchange consent is required, of information to be exchanged of the exchanging party, and wherein, if the consent required/not required information indicates required, the preliminary disclosure means preliminarily discloses the information to be exchanged for the exchanging party.

Therefore, according to the invention, as obtaining consent is previously desired, information exchange can be executed with consent obtained mutually from the exchanging parties.

The information exchange support apparatus of the invention contains an apparatus, wherein the preliminary disclosure means discloses the information to be exchanged in a mode in which the exchanging party cannot save all information to be exchanged.

Therefore, according to the invention, as the information to be exchanged is preliminarily disclosed, the exchanging party receives disclosure of the information to be exchanged, but cannot save the information, so that the preliminary disclosure does not lead to exchange of the information to be exchanged.

The information exchange support apparatus of the invention contains an apparatus, wherein the preliminary disclosure means discloses the information to be exchanged using an electronic mail system or a Web page.

The information exchange support apparatus of the invention contains an apparatus, wherein, when information exchange is executed at least among three parties, if the exchange request information of all parities are all already received, the exchange determination means determines that information exchange is permitted.

Therefore, according to the invention, when information exchange is executed at least among three parties, information exchange can be executed after the exchange conditions of all members are satisfied.

The information exchange support program of the invention is a program for causing a computer to function as an information exchange support apparatus.

The information exchange support method of the invention is an information exchange support method for supporting exchange of information through a network, the information exchange support apparatus including a reception step of receiving exchange request information containing information to be exchanged and information for identifying an exchanging party, an exchange determination step of determining whether or not information exchange is permitted using the received exchange request information, and a transmission step of transmitting the information to be exchanged to the exchanging party if the exchange determination step determines that information exchange is permitted, wherein, if the exchange request information from the mutual exchanging parties is already received, the exchange determination steps determines that information exchange is permitted.

Therefore, according to the invention, it is determined that the exchange condition of the information to be exchanged is met between the identified exchanging parties, and exchange of the information to be exchanged between the exchanging parties can be executed reliably.

### Advantages of the Invention

The information exchange support apparatus, its program, and the information exchange support method of the invention determines that the exchange condition of the information to be exchanged is met between the identified exchanging parties and can reliably execute exchange of the information to be exchanged between the exchanging parties.

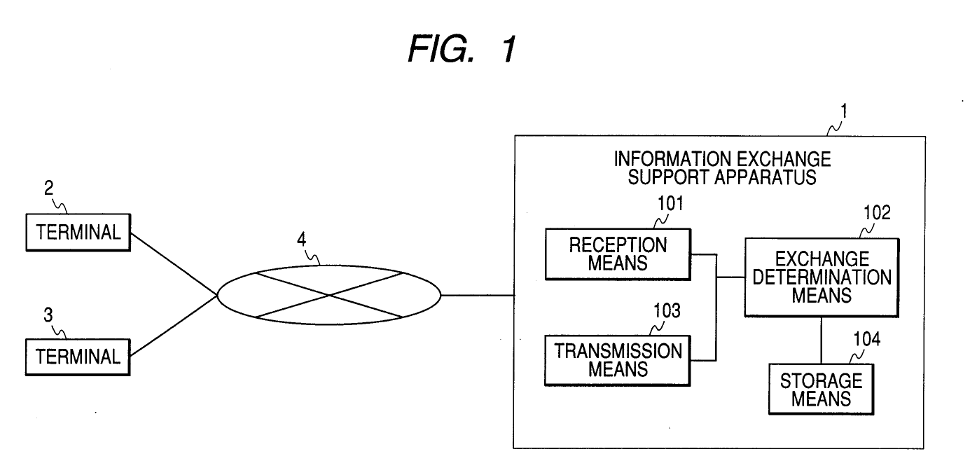

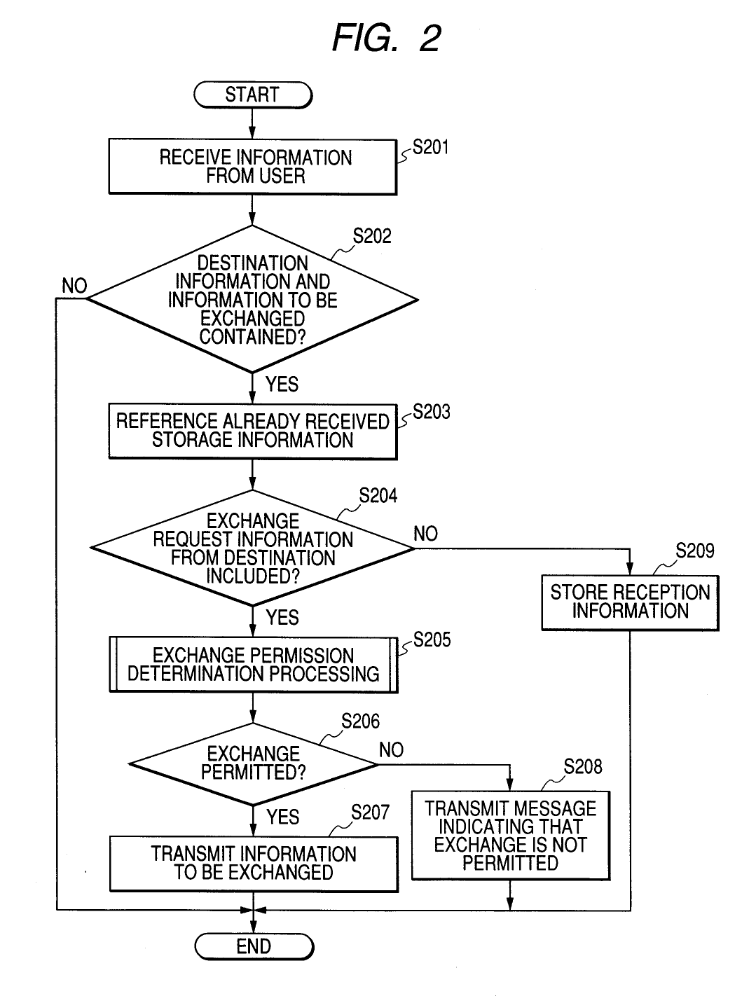

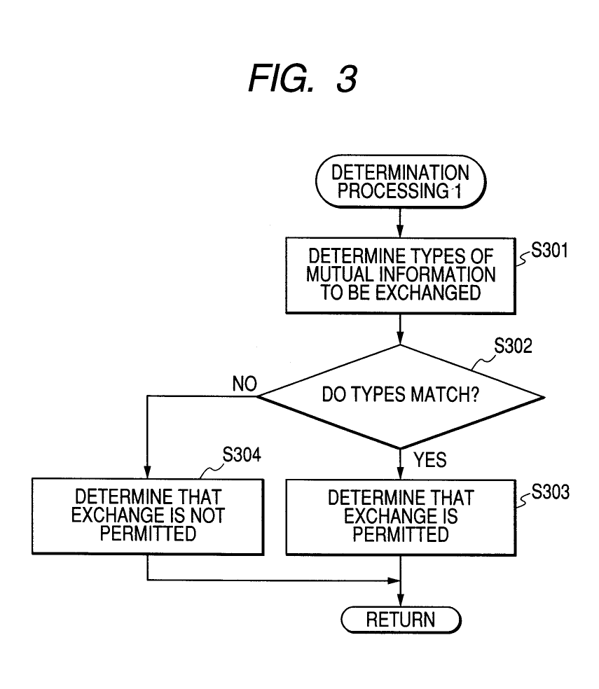

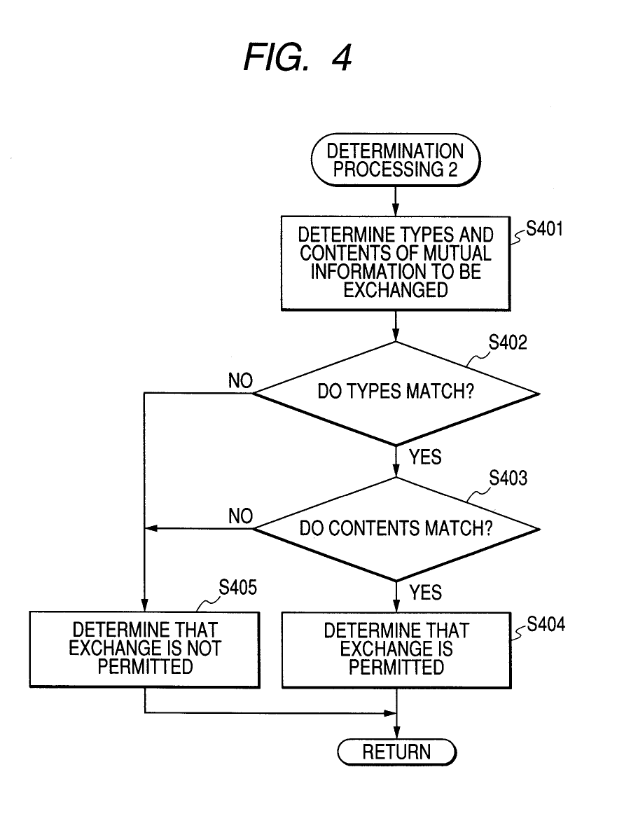

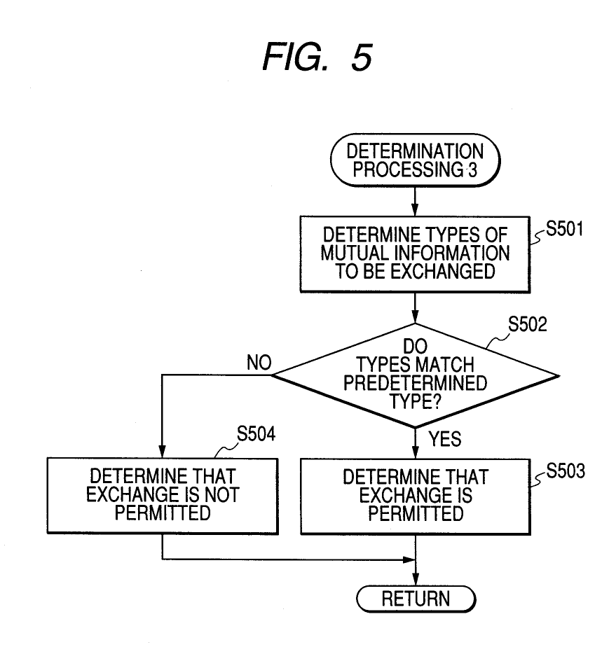

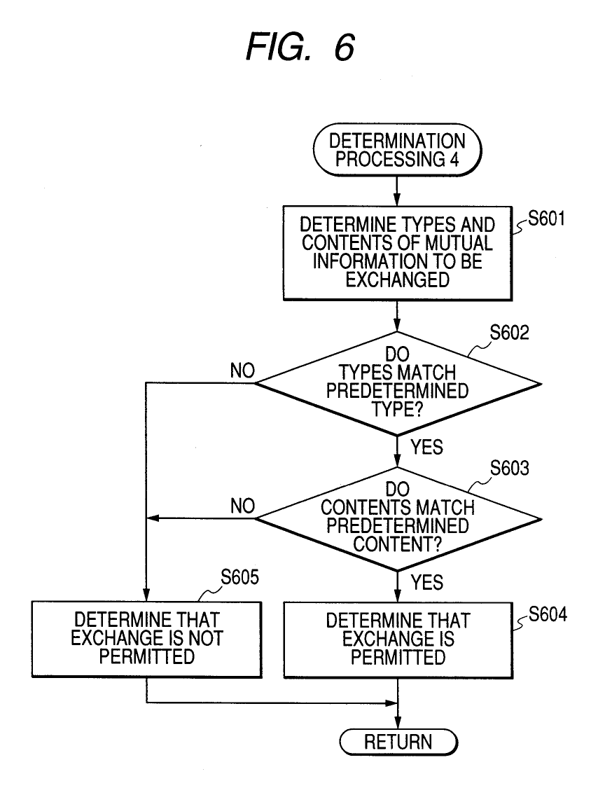

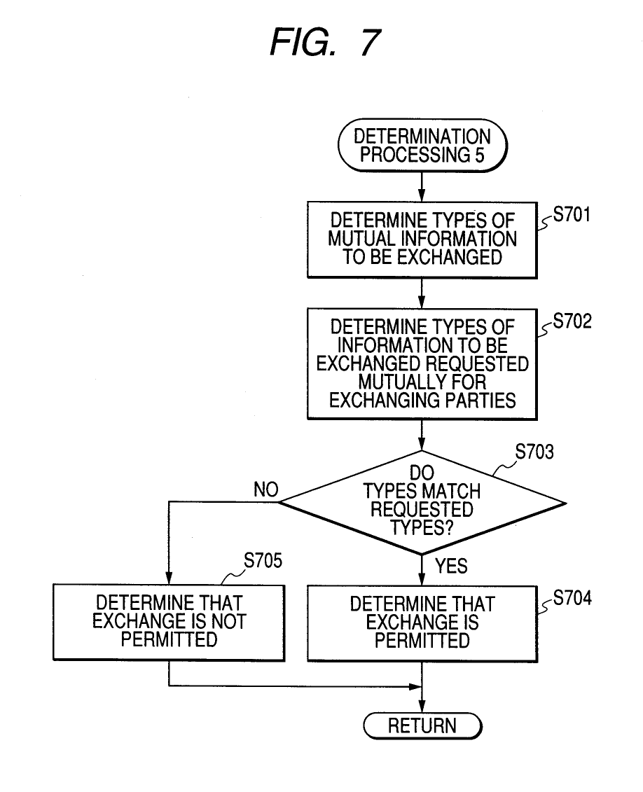

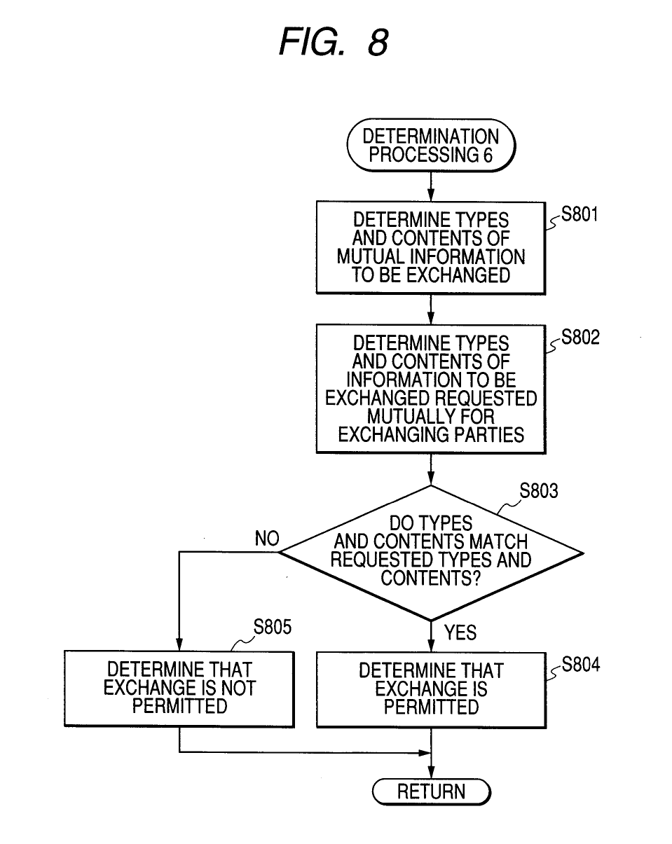

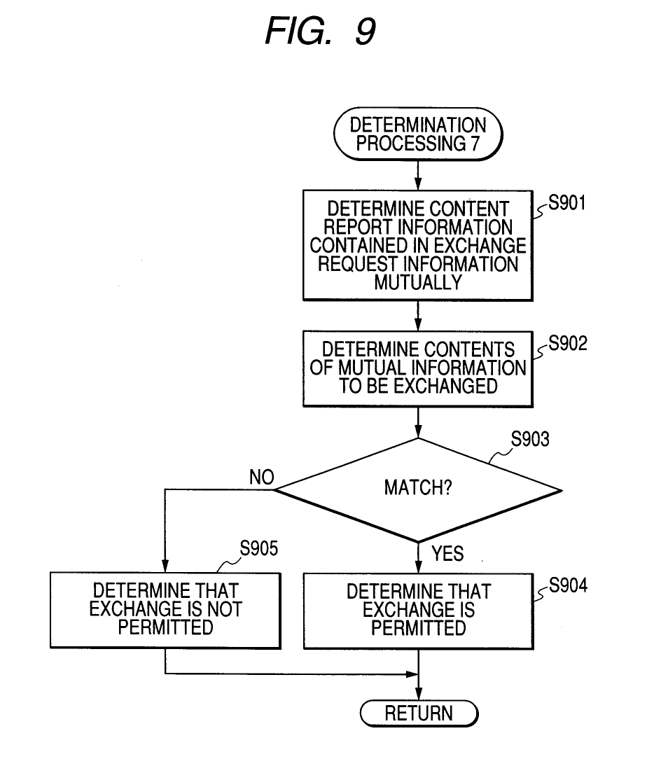

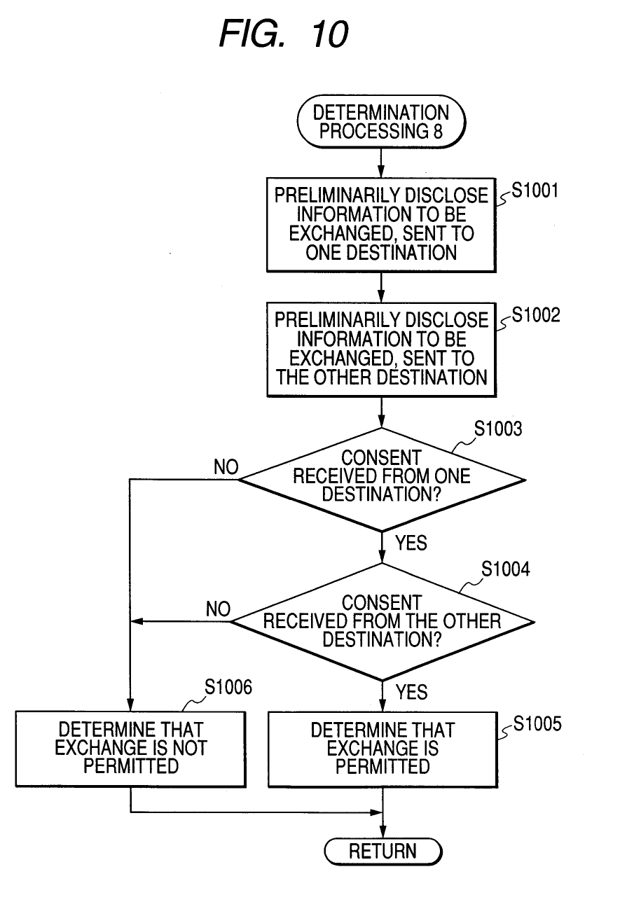

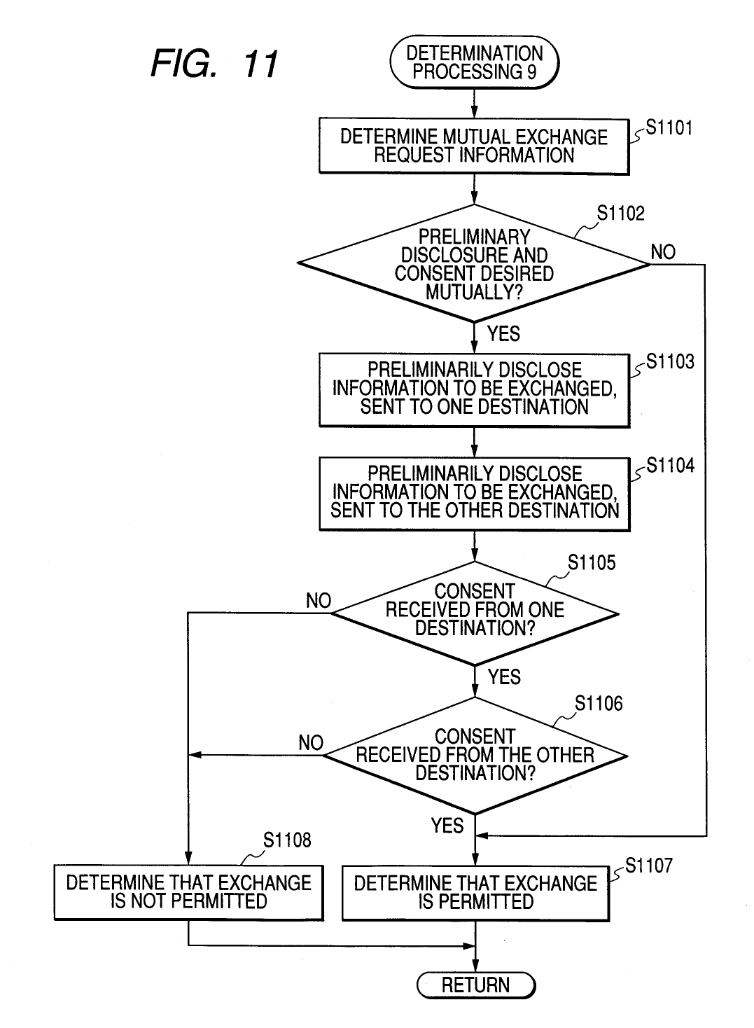

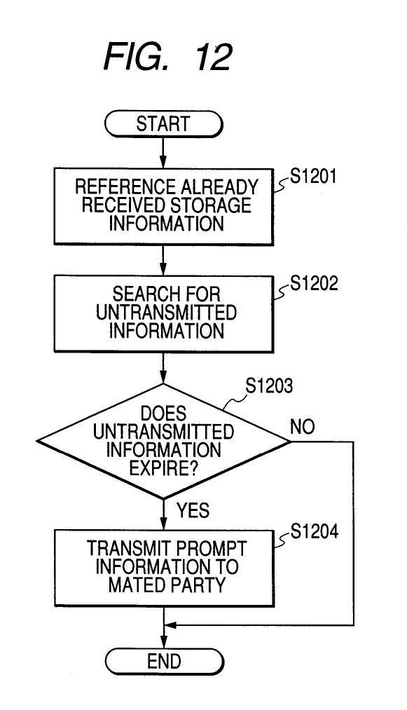

### BRIEF DESCRIPTION OF THE DRAWINGS

[FIG. 1] A drawing to show the schematic configuration of an information exchange support apparatus to describe an embodiment of the invention and the relationship among terminals and the information exchange support apparatus used for information exchange.

[FIG. 2] A flowchart to show an information exchange processing procedure of the information exchange support apparatus of the embodiment of the invention.

[FIG. 3] An operation flowchart of one example to use the type of information to be exchanged for exchange permission determination processing performed by the information exchange support apparatus of the embodiment of the invention.

[FIG. 4] An operation flowchart of one example to use the type and the content of information to be exchanged for exchange permission determination processing performed by the information exchange support apparatus of the embodiment of the invention.

[FIG. 5] An operation flowchart of another example to use the type of information to be exchanged for exchange permission determination processing performed by the information exchange support apparatus of the embodiment of the invention.

[FIG. 6] An operation flowchart of another example to use the type and the content of information to be exchanged for exchange permission determination processing performed by the information exchange support apparatus of the embodiment of the invention.

[FIG. 7] An operation flowchart of still another example to use the type of information to be exchanged for exchange permission determination processing performed by the information exchange support apparatus of the embodiment of the invention.

[FIG. 8] An operation flowchart of still another example to use the type and the content of information to be exchanged for exchange permission determination processing performed by the information exchange support apparatus of the embodiment of the invention.

[FIG. 9] An operation flowchart of one example to use the type and the content of information to be exchanged and content report information for exchange permission determination processing performed by the information exchange support apparatus of the embodiment of the invention.

[FIG. 10] An operation flowchart of one example to preliminarily disclose information to be exchanged and use the presence or absence of consent information from the associated party for exchange permission determination processing performed by the information exchange support apparatus of the embodiment of the invention.

[FIG. 11] An operation flowchart of another example to preliminarily disclose information to be exchanged and use the presence or absence of consent information from the associated party for exchange permission determination processing performed by the information exchange support apparatus of the embodiment of the invention.

[FIG. 12] An operation flowchart of processing of prompting exchange request information to be transmitted, performed by the information exchange support apparatus of the embodiment of the invention.

### DESCRIPTION OF REFERENCE NUMERALS

1. . . . Information exchange support apparatus
2 . . . . Terminal
3 . . . . Terminal
4 . . . . Network
101 . . . . Reception means
102 . . . . Exchange determination means
103 . . . . Transmission means
104 . . . . Storage means

### BEST MODE FOR CARRYING OUT THE INVENTION

FIG. 1 shows the schematic configuration of an information exchange support apparatus to describe an embodiment of the invention and the relationship among terminals and the information exchange support apparatus used for information exchange. A terminal 2 and a terminal 3 can be connected to an information exchange support apparatus 1 through a network 4 and the users of the terminals 2 and 3 execute information exchange through the information exchange support apparatus 1. FIG. 1 shows only two terminals of the terminals 2 and 3; in fact, however, a large number of terminals can be connected.

To execute information exchange with another user, the terminal 2 or 3 of the user transmits exchange request information containing the information to be exchanged and information identifying the exchanging party to the information exchange support apparatus 1 rather than transmits the information to be exchanged directly to the associated terminal 3 or 2. The information to be exchanged is information such as image information like a still image, a moving image, animation, or graphics, position information, information representing the position information on a map, sound information like audio, voice, or music, and text information (containing personal information (telephone number, e-mail address, address, taste, name, schedule, etc.,)), application (exchange of game, practical application, etc.,), or a combination thereof. The information identifying the exchanging party is information of an e-mail address or the name, nickname, etc., determining the e-mail address.

The information exchange support apparatus 1 includes reception means 101, exchange determination means 102, transmission means 103, and storage means 104. The reception means 101 receives various pieces of information containing exchange request information from the terminal 2, 3, and the transmission means 103 transmits various pieces of information containing the information to be exchanged contained in the received exchange request information to the terminal. The exchange determination means uses the received exchange request information to determine whether or not the information exchange is permitted, and the storage means 104 stores various pieces of information containing the received exchange request information. The information exchange support apparatus 1 is implemented as a server computer and the reception means 101, the exchange determination means 102, and the transmission means 103 are provided using predetermined programs.

The reception means 101 receives the exchange request information containing the information to be exchanged and the information identifying the exchanging party from the terminal 2, 3, for example, using an electronic mail system or a Web page. To receive the exchange request information using the electronic mail system, the exchange request information can be received as an attached file to electronic mail or the information to be exchanged can be received as an attached file and other pieces of the exchange request information can be received in the main body of electronic mail. To receive the exchange request information using the Web page, for example, the user is requested to make necessary entries in the Web page and to attach the information to be exchanged.

After the exchange request information is received in the reception means 101, the exchange determination means 102 references already received storage information stored in the storage means 104 and determines whether or not exchange is permitted from the received exchange request information. The determination as to whether or not exchange is permitted is described later in detail.

When the exchange determination means 102 determines that information exchange is permitted, the transmission means 103 transmits the information to be exchanged contained in the received exchange request information to the terminal of the exchanging party. The information to be exchanged is transmitted as an attached file to the electronic mail system or the information to be exchanged is placed on a Web page and electronic mail describing the address of the Web page and a viewing method is transmitted to the exchanging party.

If the exchanging party previously knows the address of the Web page and the viewing method, the information to be exchanged may be placed only on a Web page.

FIG. 2 is a flowchart to show an information exchange processing procedure of the information exchange support apparatus 1.

Upon reception of information from the user at step S201, whether or not the information contains information identifying the information exchanging party (which will be hereinafter described as destination information) and the information to be exchanged is determined at step S202.

If the determination result at step S202 indicates that the destination information and the information to be exchanged are contained, the already received storage information stored in the storage means 104 is referenced at step S203 and whether or not the exchange request information addressed to the user is received from the party matching the destination information is determined at step S204.

If the determination result at step S204 indicates that exchange request information from the destination to the source of the exchange request information received this time is not stored, the exchange request information received this time becomes the first exchange request information and therefore the exchange request information is stored in the storage means 104 at step S209. At this time, a message to the effect that the exchange request information has been stored may be returned to the user.

If the determination result at step S204 indicates that exchange request information is stored, determination processing as to whether or not exchange is permitted is performed at step S205 and the processing result at step S205 is determined at step S206. If it is determined that the exchange is permitted, the information to be exchanged is transmitted to both the parties at step S207. If it is determined at step S206 that the exchange is not permitted, a message to the effect that the exchange is not permitted is transmitted to both the parties at step S208.

Therefore, according to the invention, it is determined that the exchange condition of the information to be exchanged is met between the identified exchanging parties, and exchange of the information to be exchanged between the exchanging parties can be executed reliably.

Next, specific determination processing at step S205 will be discussed. The exchange permission determination of the invention determines that information exchange is permitted if at least exchange request information from mutual exchanging parties is already received.

First, an example when information exchange is executed between two parties is shown below: Step S205 is executed when the determination result at step S204 indicates that exchange request information from the destination exists. Thus, it can be determined that all information to be exchanged is complete according to the exchange request information received this time. Therefore, if the fact that the exchange request information from the exchanging party is already received is adopted as the determination condition, the substantial determination at step S205 is not required and it is determined that exchange is permitted.

Next, an example when information exchange is executed among at least three parties is shown below: Step S205 is executed when the determination result at step S204 indicates that exchange request information from at least one destination exists. Thus, first a determination is made whether or not all information to be exchanged is complete according to the exchange request information received this time. As the determination result, if all information to be exchanged is not yet complete, the received exchange request information is stored in the storage means 104 as at step S209, and it is determined as the exchange permission determination that exchange is not permitted.

On the other hand, if it is determined that all information to be exchanged is complete, it is determined that exchange is permitted.

In the example, when information exchange is executed among at least three parties, the exchange conditions of all members are satisfied before information exchange is executed, but information exchange may be executed solely between the two parties satisfying the exchange condition.

As the number of pieces of information to be exchanged contained in one exchange request information piece, if at least one exists, it is determined that the information to be exchanged is already received. Therefore, exchange is permitted regardless of whether the number of pieces of information to be exchanged in executing information exchange is one to one, plurality to one, or plurality to plurality.

Subsequently, the case where not only the fact that exchange request information from mutual exchanging parties is already received, but also another condition is adopted as the exchange permission determination condition will be discussed.

FIGS. 3 to 9 are flowcharts to show operation flows of exchange permission determination processing to use the type and/or the content of information to be exchanged for the exchange permission determination processing. In determination processing 1 shown in FIG. 3, the type of information to be exchanged is used. In determination processing 1, the types of mutual information to be exchanged are determined at step S301. If it is determined at step S302 that the types match, it is determined that exchange is permitted at step S303; if it is determined that the types do not match, it is determined that exchange is not permitted at step S304. The type of information to be exchanged is determined using the identifier of the attached file, etc., for example.

Therefore, the determination processing is performed, whereby the types of information to be exchanged can be matched with each other.

In determination processing 2 shown in FIG. 4, the type and the content of information to be exchanged are used. In determination processing 2, the types and the contents of mutual information to be exchanged are determined at step S401. If it is determined at step S402 that the types match and further it is determined at step S403 that the contents match, it is determined that exchange is permitted at step S404; if it is determined at step S402 or S403 that they do not match, it is determined that exchange is not permitted at step S405. The content of information to be exchanged is determined by a unique method depending on the type of information to be exchanged. For example, if the information to be exchanged is a still image, a person, a landscape, an animal, etc., is determined by performing recognition processing of image information.

Therefore, the determination processing is performed, whereby the types and the contents of the information to be exchanged can be matched with each other.

In determination processing 2 shown in FIG. 4, type match determination is made and then content match determination is made, but the determinations may be made in the inverse order.

In determination processing 2 shown in FIG. 4, the types and the contents of mutual information to be exchanged are determined at step S401 and then whether or not the types match is determined and whether or not the contents match is determined at steps S402 and S403. However, first the types of mutual information to be exchanged may be determined and whether or not the types match may be determined and then if they match, further the contents of mutual information to be exchanged may be determined and whether or not the contents match may be determined. In this case, when the types do not match, the determination as to whether or not the contents match may be skipped and therefore the computation amount can be reduced and the processing time can be shorted.

In determination processing 3 shown in FIG. 5, like determination processing 1, the type of information to be exchanged is used, but the determination manner differs therebetween. In determination processing 3, the types of mutual information to be exchanged are determined at step S501. If it is determined at step S502 that the types match the information type predetermined by the information exchange support apparatus, it is determined that exchange is permitted at step S503; if it is determined that the types do not match, it is determined that exchange is not permitted at step S504.

Therefore, the determination processing is performed, whereby the types of information to be exchanged can be matched with the predetermined type of information to be exchanged.

In determination processing 4 shown in FIG. 6, like determination processing 2, the type and the content of information to be exchanged are used, but the determination manner differs therebetween. In determination processing 4, the types and the contents of mutual information to be exchanged are determined at step S601. If it is determined at step S602 that the types match the information type predetermined by the information exchange support apparatus and further it is determined at step S603 that the contents match the information content predetermined by the information exchange support apparatus, it is determined that exchange is permitted at step S604. If it is determined at step S603 or S604 that they do not match, it is determined that exchange is not permitted at step S605.

Therefore, the determination processing is performed, whereby the types and the contents of the information to be exchanged can be matched with the predetermined type and content of information to be exchanged.

In determination processing 4 shown in FIG. 6, type match determination is made and then content match determination is made, but the determinations may be made in the inverse order.

In determination processing 4 shown in FIG. 6, the types and the contents of mutual information to be exchanged are determined at step S601 and then whether or not the types match is determined and whether or not the contents match is determined at steps S602 and S603. However, first the types of mutual information to be exchanged may be determined and whether or not the types match the information type predetermined by the information exchange support apparatus may be determined and then if they match, further the contents of mutual information to be exchanged may be determined and whether or not the contents match the information content predetermined by the information exchange support apparatus may be determined. In this case, when the types do not match, the determination as to whether or not the contents match may be skipped and therefore the computation amount can be reduced and the processing time can be shorted.

In determination processing 1 to 4, if the types and the contents of information to be exchanged match or match the predetermined type and content, it is determined that exchange is permitted, but information concerning the type and the content of information to be exchanged may be contained in the exchange request information and may be used for the exchange permission determination processing.

In determination processing 5 shown in FIG. 7, like determination processing 1, the type of information to be exchanged is used, but the determination manner differs therebetween. In determination processing 5, the types of mutual information to be exchanged are determined at step S701, and the types of information to be exchanged requested for the exchanging parties contained in mutual exchange request information are determined at step S702. If it is determined at step S703 that the types of information to be exchanged determined at step S701 match the information types determined at step S702, it is determined that exchange is permitted at step S704; if it is determined that the types do not match, it is determined that exchange is not permitted at step S705.

Therefore, the determination processing is performed, whereby the types of information to be exchanged can be matched with the requested types for the exchanging parties.

In determination processing 5 shown in FIG. 7, the types of mutual information to be exchanged are determined at step S701 and then the types of information to be exchanged requested for the exchanging parties contained in mutual exchange request information are determined at step S702, but this order may be changed so that the types of information to be exchanged requested for the exchanging parties contained in mutual exchange request information are determined and then the types of mutual information to be exchanged are determined.

In determination processing 6 shown in FIG. 8, like determination processing 1, the type and the content of information to be exchanged are used, but the determination manner differs therebetween. In determination processing 6, the types and the contents of mutual information to be exchanged are determined at step S801, and the types and the contents of information to be exchanged requested for the exchanging parties contained in mutual exchange request information are determined at step S802. If it is determined at step S803 that the types and the contents of information to be exchanged determined at step S801 match the information types and contents determined at step S802, it is determined that exchange is permitted at step S804; if it is determined that they do not match, it is determined that exchange is not permitted at step S805.

Therefore, the determination processing is performed, whereby the types and the contents of the information to be exchanged can be matched with the requested types and contents for the exchanging parties.

In determination processing 6 shown in FIG. 8, the types and the contents of mutual information to be exchanged are determined at step S801 and then the types and the contents of information to be exchanged requested for the exchanging parties contained in mutual exchange request information are determined at step S802, but this order may be changed so that the types and the contents of information to be exchanged requested for the exchanging parties contained in mutual exchange request information are determined and then the types and the contents of mutual information to be exchanged are determined.

In determination processing 6 shown in FIG. 8, the types and the contents of mutual information to be exchanged are determined at step S801 and then the types and the contents of information to be exchanged requested for the exchanging parties contained in mutual exchange request information are determined at step S802. However, first the types of mutual information to be exchanged and the types of information to be exchanged requested for the exchanging parties contained in mutual exchange request information may be determined and if they match, the contents of mutual information to be exchanged and the contents of information to be exchanged requested for the exchanging parties contained in mutual exchange request information may be determined. In this case, when the types do not match, the determination as to whether or not the contents match may be skipped and therefore the computation amount can be reduced and the processing time can be shorted.

Next, exchange permission determination processing when exchange request information contains content report information indicating the content of information to be exchanged contained in the exchange request information will be discussed.

In determination processing 1 to 4, if the types and the contents of information to be exchanged match or match the predetermined type and content, it is determined that exchange is permitted, and in determination processing 5 and 6, the information concerning the type and the content of information to be exchanged is contained in the exchange request information and is used for the exchange permission determination processing. However, content report information indicating the content of information to be exchanged may be previously added to the exchange request information and may be used to make exchange permission determination.

In determination processing 7 shown in FIG. 9, the type and the content of information to be exchanged and content report information are used. The content report information is information added to the exchange request information and is information indicating the content of information to be exchanged transmitted by the exchanging party. For example, if the information to be exchanged is an image, the content report information is information indicating that the image is an image of a person, a landscape, an animal, etc.

In determination processing 7, the content report information contained in the exchange request information is mutually determined at step S901, and the contents of mutual information to be exchanged are determined at step S902. If it is determined at step S903 that the content report information of the information to be exchanged determined at step S901 matches the content of the information to be exchanged determined at step S902, it is determined that exchange is permitted at step S904; if it is determined that they do not match, it is determined that exchange is not permitted at step S905.

Therefore, the determination processing is performed, whereby the contents of the information to be exchanged can be matched with the contents reported by the exchanging parties.

Next, the case where preliminary disclosure of information to be exchanged is made for the exchanging party and reception or no reception of exchange consent information is used as the condition of the exchange permission determination processing at step S205 will be discussed. The expression “preliminary disclosure of information to be exchanged” is used to mean disclosure for the exchanging party in a mode in which all information to be exchanged cannot be saved.

For example, if the information to be exchanged is image information like a still image, a moving image, animation, or graphics or information representing position information on a map, the resolution may be made coarse, the disclosed image may be limited to a part of the image, or the disclosure time may be limited. If the information to be exchanged is sound information like audio, voice, or music, the sound quality may be degraded or the disclosure time may be limited. If the information to be exchanged is text information, the disclosed text information may be limited to a part or the disclosure time may be limited.

FIG. 10 is a flowchart to show an example of exchange permission determination processing for performing preliminary disclosure. In determination processing 8 shown in FIG. 10, the information to be exchanged, sent to one destination is preliminarily disclosed at step S1001, and the information to be exchanged, sent to the other destination is preliminarily disclosed at step S1002. Whether or not the information exchange consent is obtained from the one destination is determined at step S1003, and whether or not the information exchange consent is obtained from the other destination is determined at step S1004. If the consent is obtained from both the destinations, it is determined at step S1005 that exchange is permitted. If the consent is not obtained from at least one of the destinations, it is determined at step S1006 that exchange is not permitted.

Therefore, the determination processing is performed, whereby information exchange can be executed with consent obtained mutually from the exchanging parties.

In determination processing 8 shown in FIG. 10, the information to be exchanged, sent to each exchanging party is preliminarily disclosed at steps S1001 and S1002, but preliminary disclosure of information sent to one destination and preliminary disclosure of information sent to the other destination may be made in any order. Likewise, the determination order of information exchange consent at steps S1003 and S1004 may be any.

In the example in FIG. 10, the information to be exchanged, sent to each exchanging party is preliminarily disclosed at steps S1001 and S1002 and then the information exchange consent is determined at steps S1003 and S1004. However, after preliminary disclosure of information sent to one destination is made, the information exchange consent may be obtained from the one destination and then preliminary disclosure of information sent to the other destination may be made and the information exchange consent may be obtained from the other destination.

In the example in FIG. 10, reception or no reception of the exchange consent information relative to the preliminary disclosure is used for exchange determination as to whether or not exchange is permitted, but exchange determination may be made in combination with determination processing 1 to determination processing 7. To make exchange determination in combination with determination processing, when the results of all combined determination processing indicate that exchange is permitted, it is determined that exchange is permitted.

FIG. 11 is a flowchart to show another example of exchange permission determination processing for performing preliminary disclosure. In determination processing 9 shown in FIG. 11, mutual exchange request information is determined at step S1101, and whether or not the mutual exchange request information contains preliminary disclosure and consent required/not required information of information to be exchanged of the exchanging party is determined at step S1102.

If it is determined at step S1102 that the exchange request information mutually contains preliminary disclosure and consent required/not required information of information to be exchanged of the exchanging party, the information to be exchanged, sent to one destination is preliminarily disclosed at step S1103, and the information to be exchanged, sent to the other destination is preliminarily disclosed at step S1104. Whether or not the information exchange consent is obtained from the one destination is determined at step S1105, and further whether or not the information exchange consent is obtained from the other destination is determined at step S1106. If the consent is obtained from both the destinations or it is determined at step S1102 that the information is not contained, it is determined at step S1107 that exchange is permitted. If the consent is not obtained from at least one of the destinations, it is determined at step S1108 that exchange is not permitted.

Therefore, the determination processing is performed, whereby as obtaining consent is previously desired, information exchange can be executed with consent obtained mutually from the exchanging parties.

In determination processing 9 shown in FIG. 11, the information to be exchanged, sent to each destination is preliminarily disclosed at steps S1103 and S1104, but preliminary disclosure of information sent to one destination and preliminary disclosure of information sent to the other destination may be made in any order. Likewise, the determination order of information exchange consent at steps S1105 and S1106 may be any.

In determination processing 9 in FIG. 11, the information to be exchanged, sent to each exchanging party, is preliminarily disclosed at steps S1103 and S1104 and then the information exchange consent is determined at steps S1105 and S1106. However, after preliminary disclosure of information sent to one transmission person is made, the information exchange consent may be obtained from the one transmission person and then preliminary disclosure of information sent to the other transmission person may be made and the information exchange consent may be obtained from the other transmission person.

In determination processing 9 in FIG. 11, the exchange consent relative to the preliminary disclosure is used for exchange determination as to whether or not exchange is permitted, but exchange determination may be made in combination with determination processing 1 to determination processing 7. To make exchange determination in combination with determination processing, when the results of all combined determination processing indicate that exchange is permitted, it is determined that exchange is permitted.

The exchange permission determination processing (step S205) in FIG. 2 has been described in detail. In the processing in FIG. 2, if exchange request information is not received from the other user although exchange request information is received from one user, information exchange is not executed. Thus, the information exchange support apparatus 1 may perform processing of prompting the other user to transmit exchange request information.

FIG. 12 is a flowchart to show an operation flow for performing processing of prompting the user to transmit exchange request information as exchange request information from the exchanging party is not received. Already received storage information is referenced at step S1201, and a search is made for exchange request information wherein information to be exchanged is untransmitted at step S1202. The elapsed time since the information exchange support apparatus received the exchange request information untransmitted is checked at step S1203 and whether or not the elapsed time is longer than a predetermined time is determined. The predetermined time may be determined by the information exchange support apparatus or may be contained in the exchange request information transmitted by each exchanging party.

If the elapsed time is longer than the predetermined time as the determination result at step S1203, information for prompting the exchanging party contained in the exchange request information to transmit exchange request information is transmitted at step S1204.

Therefore, according to the invention, if the exchanging party forgets to transmit exchange request information, the exchanging party can be prompted to transmit exchange request information.

While the invention has been described in detail with reference to the specific embodiment, it will be obvious to those skilled in the art that various changes and modifications can be made without departing from the spirit and the scope of the invention.

The present application is based on Japanese Patent Application No. 2004-112855 filed on Apr. 7, 2004, which is incorporated herein by reference.

### INDUSTRIAL APPLICABILITY

The invention can be used for an information exchange support apparatus, an information exchange support method, an information exchange support program, etc., for determining that the exchange condition of the information to be exchanged is met between the identified exchanging parties and reliably executing exchange of the information to be exchanged between the exchanging parties.

1. An information exchange support apparatus for supporting exchange of information through a network, the information exchange support apparatus comprising:
a reception unit which receives exchange request information containing information to be exchanged and information for identifying an exchanging party;
an exchange determination unit which determines whether or not information exchange is permitted using the received exchange request information; and
a transmission unit which transmits the information to be exchanged to the exchanging party if the exchange determination unit determines that information exchange is permitted,
wherein, if the exchange request information from the mutual exchanging parties is already received, the exchange determination unit determines that information exchange is permitted.

2. The information exchange support apparatus according to claim 1,
wherein, if the types of information to be exchanged contained in the exchange request information from the mutual exchanging parties match, the exchange determination unit determines that information exchange is permitted.

3. The information exchange support apparatus according to claim 1,
wherein, if the types and the contents of information to be exchanged contained in the exchange request information from the mutual exchanging parties match, the exchange determination unit determines that information exchange is permitted.

4. The information exchange support apparatus according to claim 1,
wherein, if the types or the contents of information to be exchanged match a predetermined type or content of information to be exchanged, the exchange determination unit determines that information exchange is permitted.

5. The information exchange support apparatus according to claim 1,
wherein the exchange request information contains information indicating the type of information to be exchanged requested for the exchanging party, and
wherein, if the types of information to be exchanged contained in the exchange request information from the mutual exchanging parties match the requested type for the exchanging party, the exchange determination unit determines that information exchange is permitted.

6. The information exchange support apparatus according to claim 1,
wherein the exchange request information contains information indicating the type and the content of information to be exchanged requested for the exchanging party, and
wherein, if the types and the contents of information to be exchanged contained in the exchange request information from the mutual exchanging parties match the requested type and content for the exchanging party, the exchange determination unit determines that information exchange is permitted.

7. The information exchange support apparatus according to claim 1,
wherein the exchange request information contains content report information indicating the content of information to be exchanged contained in the exchange request information, and
wherein, if the content report information matches the content of the received information to be exchanged, the exchange determination unit determines that information exchange is permitted.

8. The information exchange support apparatus according to claim 1,
wherein the reception unit receives the exchange request information using an electronic mail system or a Web page.

9. The information exchange support apparatus according to claim 1,
wherein the transmission unit transmits the information to be exchanged using an electronic mail system or a Web page.

10. The information exchange support apparatus according to claim 1, further comprising:
a preliminary disclosure unit which preliminarily discloses the information to be exchanged for the exchanging party,
wherein, if consent information indicating exchange consent is received from the mutual exchanging parties after the preliminary disclosure unit preliminarily discloses the information to be exchanged, the exchange determination unit determines that information exchange is permitted.

11. The information exchange support apparatus according to claim 10,
wherein the exchange request information contains preliminary disclosure and consent required/not required information indicating whether or not exchange consent is required, of information to be exchanged of the exchanging party, and
wherein, if the consent required/not required information indicates required, the preliminary disclosure unit preliminarily discloses the information to be exchanged for the exchanging party.

12. The information exchange support apparatus according to claim 10,
wherein the preliminary disclosure unit discloses the information to be exchanged in a mode in which the exchanging party cannot save all information to be exchanged.

13. The information exchange support apparatus according to claim 12,
wherein the preliminary disclosure unit discloses the information to be exchanged using an electronic mail system or a Web page.

14. The information exchange support apparatus according to claim 1,
wherein, when information exchange is executed at least among three parties, if the exchange request information of all parities are all already received, the exchange determination unit determines that information exchange is permitted.

15. An information exchange support program for causing a computer to function as an information exchange support apparatus according to claim 1.

16. An information exchange support method for supporting exchange of information through a network, the information exchange support apparatus comprising:
a reception step of receiving exchange request information containing information to be exchanged and information for identifying an exchanging party;
an exchange determination step of determining whether or not information exchange is permitted using the received exchange request information; and
a transmission step of transmitting the information to be exchanged to the exchanging party if the exchange determination step determines that information exchange is permitted,
wherein, if the exchange request information from the mutual exchanging parties is already received, the exchange determination steps determines that information exchange is permitted.
